(19) United States
(12) Patent Application Publication
(10) Pub. No.: US 2017/0371100 A1
(43) Pub. Date: Dec. 28, 2017

(54) OPTICAL WAVEGUIDE AND MANUFACTURING METHOD THEREOF, OPTICAL DEVICE USING THE OPTICAL WAVEGUIDE

(71) Applicant: HITACHI CHEMICAL COMPANY, LTD., Chiyoda-ku, Tokyo (JP)

(72) Inventors: Daichi SAKAI, Chiyoda-ku, Tokyo (JP); Toshihiro KURODA, Chiyoda-ku, Tokyo (JP)

(21) Appl. No.: 14/894,034

(22) PCT Filed: Mar. 16, 2015
(86) PCT No.: PCT/JP2015/057709

§ 371 Date: Mar. 24, 2016

(51) Int. Cl. G02B 6/12; G02B 6/35

(52) U.S. Cl. CPC G02B 6/12016; G02B 6/3512; G02B 2006/12104

(57) ABSTRACT

An optical waveguide at least includes: a lower clad layer; a core that is disposed on the lower clad layer and includes an entrance plane and an emission plane; and an optical path converting mirror including an inclined surface that is neither in parallel with nor orthogonal to a plane formed by the lower clad layer. The core includes a restriction release plane. When one of two portions obtained by dividing the core in two at the restriction release plane that is on the side of the entrance plane is defined as a first core pattern portion and remaining one of the two portions on the side of the emission plane is defined as a second core pattern portion, the optical path converting mirror is disposed on an optical path of the first core pattern portion or an extension of the optical path. At least a part of the light that has entered through the entrance plane is reflected by the optical path converting mirror to have an optical path converted. At least a part of light with an optical path not converted to be in a substantially orthogonal direction is emitted from the emission plane.

### TECHNICAL FIELD

The present invention relates to an optical waveguide, a manufacturing method thereof, and an optical device using the optical waveguide. More particularly, the present invention relates to a small and thin optical waveguide that can achieve branching with transmitted light of multiple modes with a small loss and with a branching ratio that can be easily controlled, a manufacturing method thereof, and an optical device using the optical waveguide in which an intensity of an optical signal can be monitored.

### BACKGROUND ART

Generally, optical cables (also referred to as optical fiber cables) can achieve high speed communications of a large amount of information, and thus are widely used for information communications for households and industries. Furthermore, the optical cables are also applied to optical communications performed by electrical components (for example, car navigation systems) in an automobile for example.

Optical interconnection techniques using optical signals have been under development to be used not only for communication fields such as a trunk line and an access system but also for information processing in routers and servers due to increasing information capacity. More specifically, an optical waveguide has been used for an optical transmission line to optically transmit a short distance signal among or within boards in routers and server apparatuses. The optical waveguide can achieve higher degree of freedom in wiring and higher density than the optical fiber does.

One available optical device has the optical waveguide and the optical fiber optically connected to each other, to use the optical fiber, featuring a small optical loss, for a portion covering a large part of the optical transmission line length, and to use the optical waveguide, serving as the optical transmission line featuring higher degree of freedom in wiring, for a portion where positioning with respect to various optical elements such as a light receiving element and a light emitting element and other like portions.

It is important to quickly and accurately recognize whether an optical signal is properly transmitted in the optical device. Thus, a mechanism for monitoring the presence or absence of the optical signal in the optical transmission line and the intensity of such signal is required.

One available method of monitoring the optical signal includes: partially branching the optical signal in the optical transmission line, and monitoring the intensity of the optical signal thus branched with a monitor light receiving element. For example, in a method described in PTL 1, two optical fibers are welded to each other with their center axes offset from each other. A part of propagating light leaking from a core portion at the welded portion is reflected by a notch surface provided to a clad of one of the optical fibers, and the intensity of this light is monitored. In a method described in PTL 2, the optical waveguide has a Y shaped branched core pattern, and a monitor light receiving element is disposed on one of optical paths of the branched core pattern.

### CITATION LIST

### Patent Literature

PTL 1: Japanese Patent Laid-Open Publication No. 2007-248732

PTL 2: Japanese Patent Laid-Open Publication No. 2000-66045

### SUMMARY OF INVENTION

### Technical Problem

Unfortunately, the method described in PTL 1 involves the offset welding requiring each of the plurality of optical fibers to be highly accurately positioned, and thus workability is low. Furthermore, there is a problem in that the branching ratio is difficult to control. There is still another problem in that the welded portion and the portion with a notched surface have relatively low rigidity. There is yet still another problem in that a large size in a direction orthogonal to the optical path for branching the optical path of an upper and lower direction hinders downsizing of an optical device.

The method described in PTL 2 also has a problem of the resolution of the Y shaped branched pattern, and a problem in that a plurality of Y shaped branched patterns are difficult to arrange. There is another problem in that the optical waveguide cannot be arranged at a narrow pitch due to a large size in a planer direction as a result of branching the optical path of the planer direction.

Furthermore, PTL 1 and PTL 2 describe techniques of achieving branching with light of a single mode, and thus the branching ratio is difficult to control for transmitted light of multiple modes.

The present invention is made to solve the problems described above, and an object of the present invention is to provide an optical waveguide that can achieve branching with transmitted light of multiple modes with a small loss, a small and thin optical waveguide with a light branching ratio that can be easily controlled, an optical waveguide that has no welding portion or notched surface, so that rigidity can be maintained, as well as a method of manufacturing these and an optical device using the optical waveguide in which the intensity of an optical signal can be monitored.

### Solution to Problem

As a result of vigorous studies, the inventors of the present invention have found out that the problems can be solved with an optical waveguide in which at least a part of light that has entered through an entrance plane and is propagated in a core of the optical waveguide has an optical path converted by an optical path converting mirror and at least a part of the remaining light is propagated to an emission plane, and thus have made the present invention based on this idea.

Specifically, an embodiment of the present invention relates to an optical waveguide at least including: a lower clad layer; a core that is disposed on the lower clad layer and includes an entrance plane and an emission plane; and an optical path converting mirror including an inclined surface that is neither in parallel with nor orthogonal to a plane formed by the lower clad layer. The core includes a restriction release plane where light that has entered through the entrance plane is first released from restriction of a side surface of the core. When one of two portions obtained by dividing the core in two at the restriction release plane that is on the side of the entrance plane is defined as a first core pattern portion and remaining one of the two portions on the side of the emission plane is defined as a second core pattern portion, the optical path converting mirror is disposed on an optical path of the first core pattern portion or an extension of the optical path. At least a part of the light that has entered through the entrance plane is reflected by the optical path converting mirror to have an optical path converted. At least a part of light with an optical path not converted to be in a substantially orthogonal direction is emitted from the emission plane.

With the optical waveguide, the entering light can be efficiently branched to be transmitted to the side of the emission plane and to the side of the optical path converting mirror. Furthermore, a ratio between an amount of light travelling in a direction toward the emission plane and an amount of light travelling in a direction toward the optical path converting mirror (hereinafter, simply referred to as “branching ratio”) can be controlled. The position of the optical path converting mirror can be easily recognized, whereby positioning in another step is facilitated. The first core pattern portion and the second core pattern portion are disposed on the same lower clad layer, and thus the position of the core in the height direction can be easily controlled, whereby a coupling loss between the first core pattern portion and the second core pattern portion can be easily reduced.

The entering light is branched to be in the direction substantially orthogonal to the lower clad layer. Thus, for example, a plurality of optical waveguides can be arranged in a space saving manner, whereby a small optical device can be obtained. Furthermore, a shape of a spot formed by the light having the optical path converted is elongated in the optical path direction. Thus, interference of the light, having the optical path converted, between the adjacent ones of the plurality of optical waveguides arranged in parallel and close to each other is less likely to occur. Thus, the amount of light and the like can be accurately monitored.

One side surface A of the first core pattern portion closest to the restriction release plane and one side surface B of the second core pattern portion that is on the same side as the side surface and is more on the side of the emission plane than an intersecting point where an edge line formed by the inclined surface and another surface of the optical path converting mirror and the side surface intersect as viewed in the direction of the normal line of the lower clad layer may not be on the same plane and may be arranged in such a manner that an intersection line between the side surface A and the restriction release plane is disposed more on the side of the optical path converting mirror than the side surface B. Thus, the optical path of part of the light can be efficiently converted.

An optical path converting mirror member including the optical path converting mirror may be further provided. The optical path converting mirror member is a column having a triangular or polygonal cross section. The optical path converting mirror member having the polygonal cross section includes an upper surface in parallel with the plane formed by the lower clad layer, a lower surface substantially in parallel with the plane formed by the lower clad layer, and a surface that is closest to the entrance plane and is substantially orthogonal to the plane formed by the lower clad layer. With the optical waveguide, an optical path of the light branched to be transmitted to the side of the optical path converting mirror can be efficiently converted to be in a direction substantially orthogonal to the plane formed by the lower clad layer. With the surface closest to the entrance plane being substantially orthogonal to the plane formed by the lower clad layer, favorable optical connection with the core can be achieved.

The one side surface A of the first core pattern portion closest to the restriction release plane and the one side surface B of the second core pattern portion that is on the same side as the side surface and is more on the side of the emission plane than the intersecting point where the edge line formed by inclined surface and the other surface of the optical path converting mirror and the side surface intersect as viewed in the direction of the normal line of the lower clad layer may not be on the same plane and may be arranged in such a manner that the intersection line between the side surface A and the restriction release plane is closer to the optical path converting mirror than the side surface B. With this configuration, a light component that cannot be introduced from the first core pattern portion to the second core pattern portion can be intentionally generated. With the optical path converting mirror disposed on the optical path of such light, the part of the entering light can be efficiently propagated to the optical path converting mirror. The branching ratio can be easily controlled by adjusting a distance between the side surface A and the side surface B (hereinafter, referred to as “step-like difference”).

At least a part of the optical path converting mirror may be disposed to overlap with an extension of one side surface of the first core pattern portion and an extension of one side surface of the second core pattern portion. Thus, the optical path of the part of the light can be efficiently converted.

The first core pattern and the second core pattern may be optically connected to each other, and the optical path converting mirror may be disposed in such a manner that the edge line formed by the inclined surface and the other surface is disposed closer to the emission plane than the restriction release plane. Thus, the coupling loss between the first core pattern portion and the second core pattern portion can be more easily reduced.

The optical path converting mirror and the second core pattern portion may be physically connected to each other. Thus, the entering light can be propagated with a small loss with the optical path converting mirror and the second core pattern portion.

A cross-sectional area of the first core pattern portion on the restriction release plane may be larger than a cross-sectional area of the second core pattern emission plane. Thus, a side surface of the first core pattern portion on the side of the optical path converting mirror and a side surface 201 of the second core pattern can be disposed on different planes, and another side surface of the first core pattern portion and another side surface 202 of the second core pattern portion can be smoothly connected to each other easily. Thus, the light travelling toward the emission plane can be propagated with a small loss.

An upper clad layer 5 disposed over the lower clad layer to at least partially cover the core and the optical path converting mirror member may further be provided. Thus, a large portion of the core 1 and the optical path converting mirror member 3 can be protected. When the upper clad layer 5 is provided, an opening is preferably formed in the upper clad layer 5, so that at least a part of the optical path converting mirror member comes into contact with a material with a smaller refractive index than the optical path converting mirror member. The part of the optical path converting mirror member 3 exposed through the opening 9 functions as the optical path converting mirror 301 of an air reflection type.

One embodiment of the present invention relates to an optical device including: the optical waveguide described above; a light emitting element that emits light onto the entrance plane; a monitor light receiving element that receives at least a part of the light having an optical path converted by the optical path converting mirror; and a light receiving element that receives the light emitted from the emission plane.

One embodiment of the present invention relates to a manufacturing method of the optical waveguide. Specifically, the method includes: a first step of forming at least one optical path converting mirror member, including an inclined surface, on a lower clad layer; and a second step of forming a first core pattern portion and a second core pattern portion that covers a part of the inclined surface of the optical path converting mirror member. With the manufacturing method, the optical waveguide or the optical device can be efficiently produced.

In the second step, the optical path converting mirror may be obtained by laminating core pattern forming resin to bury the optical path converting mirror member, and removing the core pattern forming resin on at least a part of the inclined surface. Thus, the second core pattern portion and the optical path converting mirror can be efficiently formed, and the optical path converting mirror and the second core pattern portion can be disposed with a high positioning accuracy.

A third step of forming an upper clad layer to bury at least a part of the core, and then forming an opening on the optical path converting mirror may be further performed. The optical path converting mirror thus intentionally exposed can sufficiently convert the optical path even when displacement between the opening and the optical path converting mirror occurs.

### Advantageous Effects of Invention

An optical waveguide of the present invention can provide a small and thin optical waveguide that can achieve branching with transmitted light of multiple modes with a small loss and with a branching ratio that can be easily controlled, a manufacturing method thereof, and an optical device using the optical waveguide in which an intensity of an optical signal can be monitored.

### BRIEF DESCRIPTION OF DRAWINGS

FIG. 1 includes a schematic plan view and schematic cross-sectional views illustrating one example of an optical waveguide of the present invention.

FIG. 2 includes a schematic plan view and schematic cross-sectional views illustrating another example of the optical waveguide of the present invention.

FIG. 3 includes a schematic plan view and schematic cross-sectional views illustrating still another example of the optical waveguide of the present invention.

FIG. 4 includes a schematic plan view and schematic cross-sectional views illustrating yet still another example of the optical waveguide of the present invention.

FIG. 5 includes schematic plan views illustrating other examples of the optical waveguide of the present invention.

FIG. 6 includes schematic cross-sectional views illustrating an example of an optical path converting mirror member.

FIG. 7 includes a schematic perspective view and a schematic plan view illustrating one example of a core and an optical path converting mirror member partially buried in the core.

FIG. 8 is a schematic perspective view illustrating one example of the optical waveguide of the present invention.

FIG. 9 includes schematic perspective views illustrating one example of a manufacturing method for the optical waveguide of the present invention.

### DESCRIPTION OF EMBODIMENTS

### (Definition)

In this specification, “substantially parallel” indicates that two lines or planes are completely parallel to each other or form an angle not lager than 3°. The angle is preferably not larger than 2°, more preferably not larger than 1°, even more preferably not larger than 0.5°, yet even more preferably not larger than 0.3°, and extremely preferably not larger than 0.1°.

In this specification, “substantially orthogonal” indicates that two lines or planes are completely orthogonal to each other (90°) or form an angle of 90° with a tolerance not larger than ±3°, preferably not larger than ±2°, more preferably not larger than ±1°, even more preferably not larger than ±0.5°, yet even more preferably not larger than ±0.3°, and extremely preferably not larger than ±0.1°.

### (1. Configuration)

An optical waveguide and an optical device of the present invention are described in detail below.

### (Optical Waveguide)

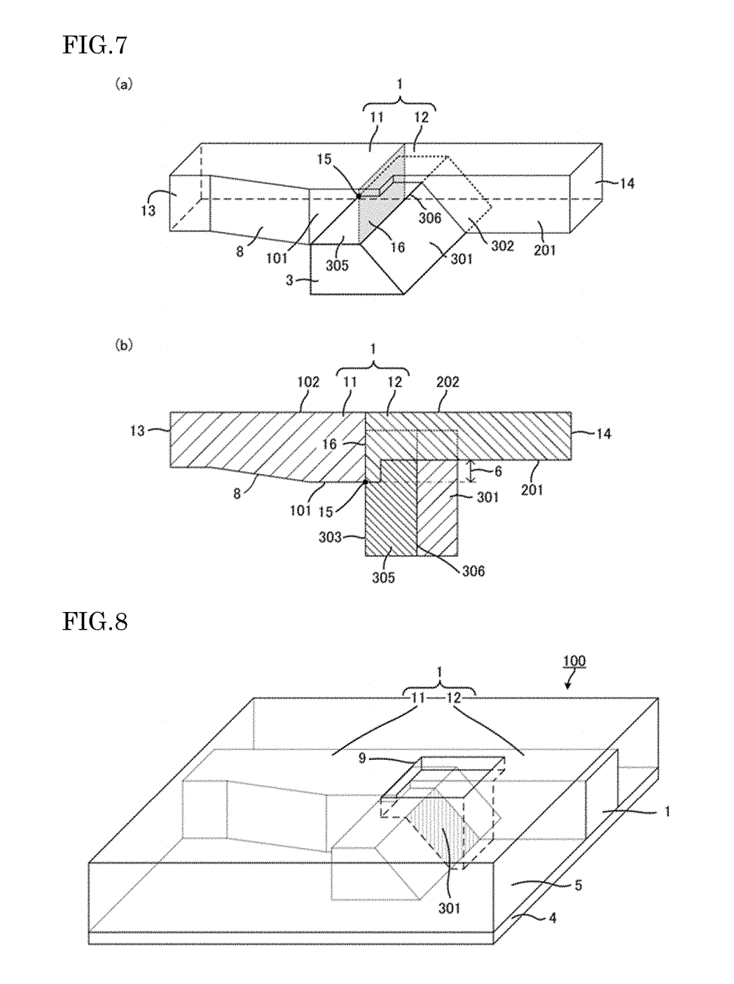

FIG. 8 illustrates one embodiment of the optical waveguide of the present invention. The optical waveguide of the present invention at least includes: a lower clad layer 4; a core 1 that is disposed on the lower clad layer 4 and has an entrance plane 13 and an emission plane 14; and an optical path converting mirror 301 having an inclined surface that is neither in parallel with nor orthogonal to a plane formed by the lower clad layer 4. In FIG. 8, 5 denotes an upper clad layer that may or may not be provided as described later. Preferably, when provided, the upper clad layer 5 preferably has an opening 9. With the opening 9, the inclined surface of an optical path converting mirror member 3 partially has an interface with a matter (air in this example) having a lower refractive index than the optical path converting mirror member 3, whereby a portion in FIG. 8 denoted by 301 functions as the optical path converting mirror. When the upper clad layer 5 is not provided, a portion (denoted by 301 in FIG. 7 described later) of the inclined surface of the optical path converting mirror member 3 not buried in the core 1 functions as the optical path converting mirror.

The core 1 includes a restriction release plane where light that has entered through the entrance plane 13 is released from restriction of side surfaces of the core 1. The light that has entered through the entrance plane 13 propagates through the core 1 toward the emission plane 14. In the optical waveguide of the present invention, a portion where light components not reflected by the side surfaces of the core 1 is are generated or a portion involving no reflection by the side surfaces is intentionally formed. In this specification, a point in this portion where the restriction by the side surfaces of the core is released is referred to as a “restriction release point”.

FIG. 7 only illustrates the core 1 and a portion of the optical path converting mirror member 3 partially buried in the core 1, in the optical waveguide of the present invention. FIG. 7(a) is a perspective view and FIG. 7(b) is a plan view. A configuration of the optical waveguide is described with reference to FIG. 7(b).

The light that has entered through the entrance plane 13 (entering light) travels toward the emission plane 14 while being reflected by the side surfaces. The core 1 is optically connected to the optical path converting mirror member 3 partially buried in the core 1. Thus, a portion where an optical path of the core 1 overlaps with the optical path converting mirror member 3 involves no reflection by the side surfaces of the core 1. A point in such a portion is the restriction release point in FIG. 7.

In this specification, there might be a plurality of the restriction release points, and one of such restriction release points that satisfies the following conditions (1) to (4) is referred to as “particular restriction release point 15”. In this specification, a plane that passes through the particular restriction release point 15 and is in parallel with an edge line (upper end side) of the optical path converting mirror is referred to as “restriction release plane 16”.

(1) A point that is on an edge line 306 of the optical path converting mirror or is closer to the entrance plane 13 than the edge line 306.

(2) A point that is closer to the entrance plane 13 than the optical path converting mirror 301 and is on a side surface of the core 1 on the side of the optical path converting mirror 301.

(3) A point where a light component of the light propagating through the core 1 that is not reflected by the side surfaces satisfying the conditions (1) and (2) is generated or a point where the light is not reflected by the side surfaces.

(4) One of the points satisfying the condition (3) that is closest to the edge line 306 of the optical path converting mirror.

In the optical waveguide of the present invention, when one of two portions obtained by dividing the core 1 in two at the restriction release plane 16 that is on the side of the entrance plane 13 is defined as a first core pattern portion 11 and the other one of the two portions that is on the side of the emission plane 14 is defined as a second core pattern portion 12, the optical path converting mirror 301 is disposed on an optical path of the first core pattern portion 11 or on an extension of the optical path. A configuration is established in which the light that has entered through the entrance plane 13 is at least partially reflected by the optical path converting mirror 301 to have the optical path converted, and at least a part of the light with the optical path not converted to be in a substantially orthogonal direction is emitted from the emission plane 14.

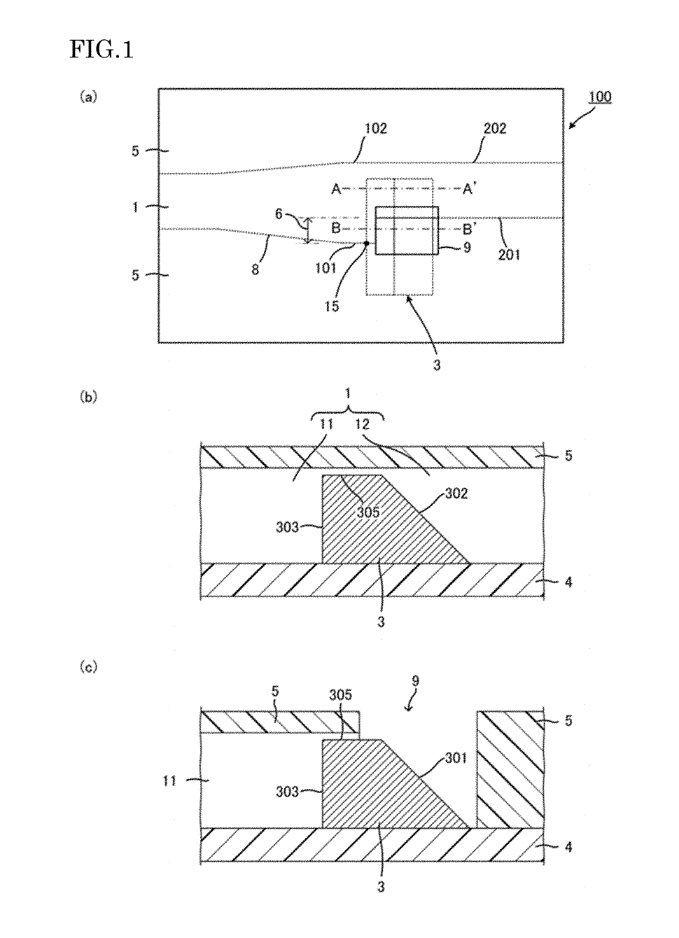

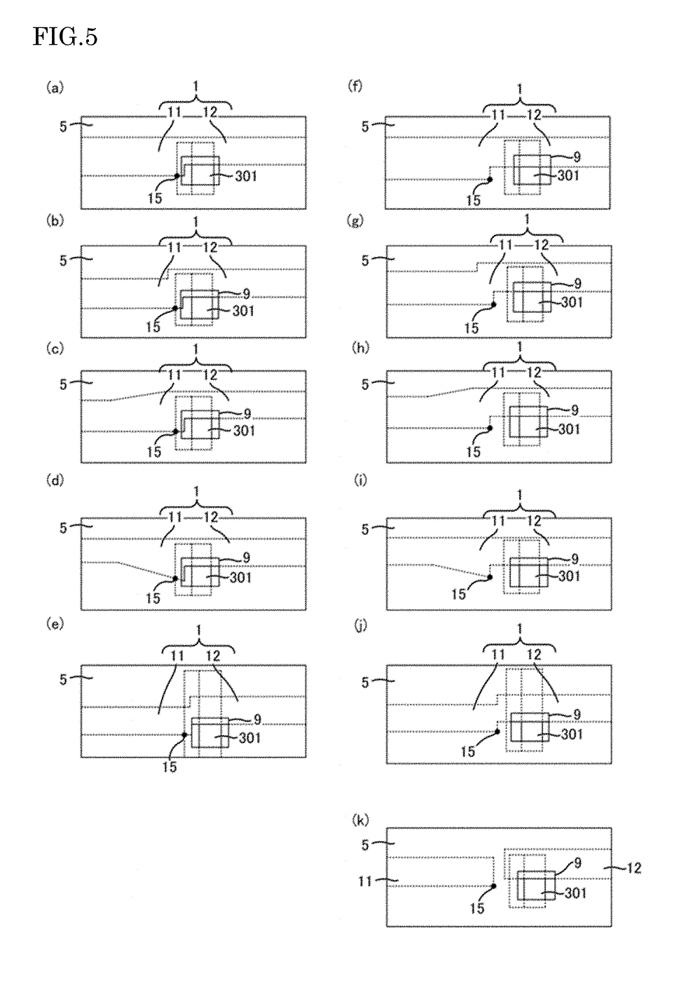

Examples of the embodiment of the optical waveguide of the present invention are illustrated in FIGS. 1 to 5. FIGS. 1(a), 2(a), 3(a), and 4(a) are each a schematic plan view of the optical waveguide. FIGS. 1(b), 2(b), 3(b), and 4(b) are each a schematic cross-sectional view taken along line A-A′. FIGS. 1(c), 2(c), 3(c), and 4(c) are each a schematic cross-sectional view taken along line B-B′. FIG. 5 includes schematic plan views of embodiments of the optical waveguide different from those illustrated in FIGS. 1 to 4. The restriction release point and the restriction release plane are described more in detail with reference to these figures.

### (Particular Restriction Release Point)

In configurations illustrated in FIGS. 1, 2, and 5(a) to 5(e), a side surface (a side surface on a lower side in the figures) of the core 1 functioning as a reflecting side surface is in physical connection with the optical path converting mirror member 3. Here, the particular restriction release point 15 is an intersecting point between the side surface (the side surface on the lower side in the figures) of the core 1 on the side of the optical path converting mirror 301 and the optical path converting mirror member 3. This is because in a portion closer to the emission plane (toward the right in the figures) than the particular restriction release point 15, a part of the light starts to propagate in the optical path converting mirror member 3, and thus a light component expanding outward (toward the lower side in the figures) from the side surface (the side surface on the lower side in the figures) of the core 1 is generated.

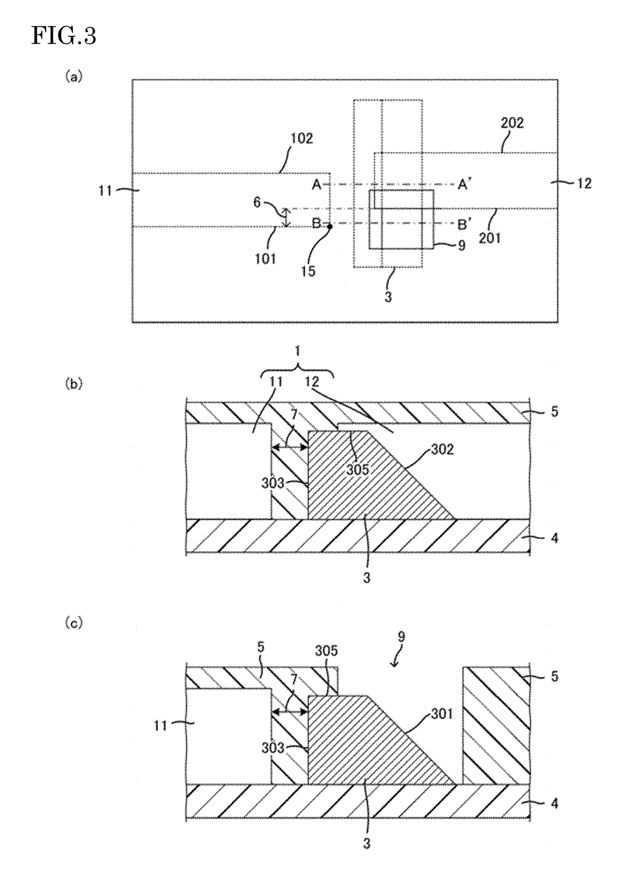

In configurations illustrated in FIGS. 3, 4, and 5(k), the core 1 is divided into the two core pattern portions 11 and 12, and a physical gap 7 is provided between the first core pattern portion 11 and the optical path converting mirror member 3. Here, the particular restriction release point 15 is an end point of the side surface (the side surface on the lower side in the figures) of the first core pattern portion 11 on the side of the optical path converting mirror 301. This is because the light is radially emitted toward the optical path converting mirror member 3 in a portion closer to the emission plane (toward the right in the figures) than the particular restriction release point 15, and is light without the side surface reflection in the first core pattern portion 11 in a portion closer to the entrance plane 13 (left side in the figures) than the optical path converting mirror 301.

In configurations illustrated in FIGS. 5(f) to 5(j), the particular restriction release point 15 is a point where a light component output to the outside of the core pattern is generated, that is, a point of the core 1 that is closer to the entrance plane 13 (toward the left in the figures) than the optical path converting mirror member 3 and is at a portion where a step-like difference is formed on the side surface (the side surface on the lower side in the figures) on the side of the optical path converting mirror 301. This is because the light propagating out of the core 1 (light involving no side surface reflection) is generated at least at the portion that is closer to the emission plane 14 than the step-like difference.

When a range in which the reflection by the side surface (the side surface on the lower side in the figures) occurs, in the portion of the core 1 closer to the entrance plane 13 than the optical path converting mirror 301, reaches the optical path converting mirror 301, the particular restriction release point 15 is an intersecting point between the edge line 306 of the optical path converting mirror and the side surface (the side surface on the lower side in the figures) of the core 1.

### (Restriction Release Plane)

The restriction release plane is a plane that passes through the particular restriction release point described above, is in parallel with the edge line 306 of the optical path converting mirror, and is substantially orthogonal to the lower clad layer 4. In this specification, the core closer to the entrance plane 13 than the restriction release plane 16 is referred to as the first core pattern portion 11, and the core closer to the emission plane 14 than the restriction release plane 16 is referred to as the second core pattern portion 12.

The first core pattern portion 11 and the second core pattern portion 12 may be integrated to form the single core 1 (as illustrated in FIGS. 1, 2, and 5(a) to 5(j)) or may each be an independent pattern (as illustrated in FIGS. 3, 4, and 5(k)), as long as the advantageous effects of the present invention can be obtained. The single core 1 including the first core pattern portion 11 and the second core pattern portion 12 that are integrated can achieve a small optical loss and thus is preferable.

As illustrated in FIG. 7, the restriction release plane 16 is a plane that passes through the particular restriction release point 15, is in parallel with the edge line 306 of the optical path converting mirror, and is substantially orthogonal to the lower clad layer 4. The core 1 as a single member in FIG. 7(a) has the first core pattern portion 11 as a core closer to the entrance plane 13 than the restriction release plane 16 and the second core pattern portion 12 as the core closer to the emission plane than the restriction release plane 16.

The optical waveguide according to the present embodiment includes the second core pattern portion 12 and the optical path converting mirror 301 disposed close to each other on the optical path of the first core pattern portion 11. Thus, the light that has propagated through the first core pattern portion 11 can be efficiently branched to be transmitted toward the second core pattern portion 12 and transmitted toward the optical path converting mirror 301. With a border position between the optical path converting mirror 301 and the second core pattern portion 12 set to an appropriate position in a direction that is substantially orthogonal to the optical path of the first core pattern portion 11 and in a direction that is in parallel with the lower clad layer 4, the light that has propagated from the first core pattern portion 11 can be controlled with a predetermined branching ratio. Furthermore, the position of the optical path converting mirror 301 can be easily recognized, whereby positioning can be easily performed in a process of installing a monitor light receiving element executed later.

The first core pattern portion 11 and the second core pattern portion 12 are disposed on the same lower clad layer 4, whereby the position of the first core pattern portion 11 and the second core pattern portion 12 in a height direction can be easily controlled. Thus, a small coupling loss from the first core pattern portion 11 to the second core pattern portion 12 can be achieved.

The optical waveguide of the present invention can branch the light to be in the direction orthogonal to the lower clad layer 4. Thus, a plurality of the optical waveguides of the present invention can be disposed close to each other to be arranged in parallel, whereby an optical device with a small size can be obtained. Because the branched direction of the optical path is on a side parallel to the lower clad layer 4, a thin optical device can be obtained.

In an aspect of the present embodiment, the optical path conversion is performed by branching involving inclination of the optical path toward a normal line of the lower clad layer 4 (for example, inclination by 30° or more from the plane formed by the lower clad layer 4). Thus, when a monitor light receiving element is disposed on an optical path conversion side (when the branching ratio has a smaller value for the optical path conversion side), a spot of the light as a result of the optical path conversion is generally elongated substantially in an optical path direction. Thus, for example, even when the optical waveguide of the aspects of the present embodiment are arranged substantially in parallel with the direction orthogonal to the optical path and arranged close to each other, interference of light as the result of the optical path conversion from adjacent optical path converting mirrors is less likely to occur. Thus, the amount of light and the like can be accurately monitored.

### (Core)

The optical waveguide of the present invention includes the core 1 including the entrance plane 13 and the emission plane 14. As described above, the core 1 includes the restriction release plane 16 where the restriction of the entering light is first released, and can be separated into the first core pattern portion 11 and the second core pattern portion 12 at the restriction release plane 16. Still, the first core pattern portion 11 and the second core pattern portion 12 need not to be physically separated from each other, and may be integrated to form the single core 1. The single core 1 including the first core pattern portion 11 and the second core pattern portion 12 that are integrated can achieve a small loss and thus is preferable.

### (Cross-Sectional Shape of Core)

A cross-sectional shape of the core 1 (a shape of a cross section orthogonal to the optical path) is not particularly limited, but is preferably a substantially rectangular shape. With the substantially rectangular shape, excellent optical introducing between the first core pattern portion 11 and the second core pattern portion 12 can be achieved and the shape of the spot of an output from the optical path converting mirror 301 can be easily controlled.

### (Thickness of Core)

The thickness of the core 1, which is not particularly limited, is generally adjusted to 10 to 100 μm. When the core 1 has a thickness of 10 μm or more, a positioning tolerance for coupling with a light emitting element (the light receiving element includes an optical path such as an optical fiber through which light is output) is likely to be large. In this context, the thickness of the core 1 is more preferably 15 μm or more, even more preferably 20 μm or more, particularly preferably 25 μm or more, and extremely preferably 30 μm or more. With the thickness of 100 μm or less, the optical waveguide as a whole can have a small thickness. In this context, the thickness is preferably 90 μm or less, more preferably 80 μm or less, and particularly preferably 70 μm or less.

### (Width of Core)

The width of the core 1, which is not particularly limited, is generally adjusted to 10 to 100 μm. When the core 1 has a width of 10 μm or more, a positioning tolerance for coupling with a light emitting element (the light receiving element includes an optical path such as an optical fiber through which light is output) is likely to be large. In this context, the width of the core 1 is more preferably 15 μm or more, even more preferably 20 μm or more, particularly preferably 25 μm or more, and is extremely preferably 30 μm or more. With the width of 100 μm or less, the optical waveguide can be downsized. In this context, the width is preferably 90 μm or less, more preferably 80 μm or less, and particularly preferably 70 μm or less. Portions of the first core pattern portion 11 with a tapered shape and an enlarged shape can be selected as appropriate to obtain a desired branching ratio, and thus are not limited to the ranges described above.

### (Step-Like Difference)

In the optical waveguide of the present invention, one side surface A of the first core pattern portion 11 at a portion closest to the restriction release plane 16 and one side surface B of the second core pattern portion 12 on the same side as the side surface A and is on the side of the entrance plane 13 with respect to an intersecting point where the edge line 306 defined by the inclined surface and another surface of the optical path converting mirror 301 as viewed in the normal line direction of the lower clad layer 4 and the side surface intersect are preferably not on the same plane, and are arranged in such a manner that an intersecting line between the side surface A and the restriction release plane 16 is disposed closer to the optical path converting mirror 301 than the side surface B. The first core pattern portion 11 and the second core pattern portion 12 may have the same width or may have different widths.

More specifically, for example, as illustrated in FIG. 7, one side surface 101 of the first core pattern portion 11 on the side of the optical path converting mirror 301 and one side surface 201 of the second core pattern portion 12 are preferably not on the same plane in a portion near the restriction release plane 16. Furthermore, the one side surface 201 of the second core pattern portion 12 is preferably shifted from the one side surface 101 of the first core pattern portion 11 in a direction opposite to the optical path converting mirror 301. A resultant distance between the side surfaces 101 and 201 is referred to as a step-like difference 6 in this specification. By thus arranging the side surface 101 of the first core pattern portion 11 and the side surface 201 of the second core pattern portion in the offset manner, a light component that cannot be transmitted from the first core pattern portion 11 to the second core pattern portion 12 can be intentionally generated. By providing the optical path converting mirror 301 on the optical path of such light, a part of the light propagating in the first core pattern portion 11 can be efficiently propagated to the optical path converting mirror 301. Furthermore, an advantage can be obtained that the branching ratio between the direction toward the second core pattern portion 12 and the direction toward the optical path converting mirror 301 can be controlled by selecting the step-like difference 6 as appropriate.

When the branching is achieved based on a nature of the light propagating in the optical path converting mirror member 3 that is more likely to spread toward the optical path converting mirror 301 than travelling toward the side surface 201 of the second core pattern portion 12, the step-like difference 6 on the extension of the side surface 101 of the first core pattern portion 11 and the extension of the side surface 201 of the second core pattern portion 12 and may not be provided. Still, the step-like difference 6 is preferably provided because a certain intensity of the branched light can be ensured and the predetermined branching ratio can be more easily ensured.

The amount of the step-like difference 6 can be adjusted as appropriate in accordance with the desired branching ratio, a width ratio between the first core pattern portion 11 and the second core pattern portion 12, and a height ratio between the optical path converting mirror member 3 and the second core pattern portion 12. More specifically, the difference between the optical path converting mirror member 3 and the second core pattern portion 12 in the height is within 50%, preferably within 70%, and more preferably within 90% (for example, the difference in the height is 90% when the height of the second core pattern portion 12 is 50 μm and the height of the optical path converting mirror member 3 is 45 μm). When the amount of light to have optical path converted by the optical path converting mirror 301 should be smaller than the amount of light propagated to the second core pattern portion 12, a ratio between the amount of the step-like difference 6 and the width of the second core pattern portion 12 is 0.1:99.9 to 49.9:50.1, more preferably 5:95 to 45:55, and even more preferably 8:92 to 40:60. Thus, the branching ratio can be stably ensured.

Side surfaces of the first core pattern portion 11 and the second core pattern portion 12 on a side opposite to the optical path converting mirror 301 (a side surface 102 of the first core pattern portion 11 and a side surface 202 of the second core pattern portion 12) described above are not particularly limited. Still, when the optical path converting mirror member 3 is formed through the first core pattern portion 11 and/or the second core pattern portion 12 as illustrated in FIGS. 3, 4, 5(e), and 5(j), or when the gap 7 is provided between the first core pattern portion 11 and the second core pattern portion 12 as illustrated in FIGS. 3, 4, and 5(k), to prevent the optical loss from increasing due to the leakage of light, the side surface 202 of the second core pattern portion 12 is preferably disposed at a position farther from the optical path converting mirror 301 than the side surface 102 of the first core pattern portion 11.

A change between side surface positions of the side surface 102 of the first core pattern portion 11 and the side surface 202 of the second core pattern portion 12 may be in a step-like form as illustrated in FIGS. 3, 4, 5(b), 5(e), 5(j), and 5(k), or may be in a smooth form (for example, with an obtuse angle not smaller than 150° or with a curved form with a round corner) as illustrated in FIGS. 1, 2, 5(c), and 5(h).

When the first core pattern portion 11 and the second core pattern portion 12 are integrated and the optical path converting mirror member 3 is not formed through the second core pattern portion 12 as illustrated in FIGS. 1, 2, 5(a) to 5(d), and 5(f) to 5(i), the change in the step-like form or in the smooth form may be provided or the surfaces may be on the same plane. The modes illustrated in FIGS. 1, 2, 5(a) to 5(d), and 5(f) to 5(i) feature a large degree of freedom in arrangement and small shape limitation of the first core pattern portion 11 and the second core pattern portion 12 and thus are most preferable. In other words, a mode where one of the side surfaces that is substantially orthogonal to the optical path of the optical path converting mirror member 3 is buried with the second core pattern portion 12 is most preferable.

The first core pattern portion 11 may be provided with a tapered portion 8 with a width increasing toward the transmitting direction on the optical path. Thus, the light propagating in the first core pattern portion 11 is reflected by a surface of the tapered portion 8 to be substantially parallel light. Thus, the coupling loss with respect to the monitor light receiving element can be more easily reduced with a smaller angle of light output from the optical path converting mirror 301.

### (Optical Path Converting Mirror Member and Optical Path Converting Mirror)

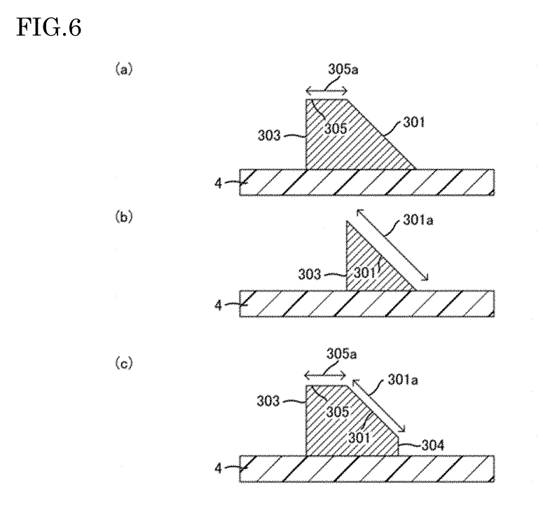

The optical waveguide of the present invention includes the optical path converting mirror having an inclined surface that is neither in parallel with nor orthogonal to the plane formed by the lower clad layer. The optical path converting mirror may be formed by directly processing the core with a laser or the like. Alternatively, the optical path converting mirror member 3 may be provided separately from the core and include the optical path converting mirror. A mode in which the optical path converting mirror member 3 provided with the optical path converting mirror is employed can be manufactured and designed easily and thus is preferable. The optical path converting mirror member 3 is a pattern at least protruding from a surface of the lower clad layer 4 as illustrated in FIG. 6, and is a pattern partially provided with an inclined surface functioning as the optical path converting mirror 301. For the sake of description, a mode in which the optical path converting mirror member 3 is provided on the lower clad layer 4 and a part of the inclined surface thereof functions as the optical path converting mirror 301 is described below as an example.

### (Shape of Optical Path Converting Mirror)

FIG. 6 illustrates specific examples of the cross-sectional shapes of the optical path converting mirror member 3. FIG. 6(a) illustrates a half trapezoid shape including the inclined surface (optical path converting mirror 301) on the side of the second core pattern portion 12, a substantially orthogonal surface 303 on the side of the first core pattern portion 11, and an upper surface 305 connecting between the inclined surface 301 and the substantially orthogonal surface. A right triangle shape with the inclined surface 301 connected to the substantially orthogonal surface 303 as illustrated in FIG. 6(b) and a shape with a substantially orthogonal surface 304 connected to the inclined surface as illustrated in FIG. 6(c) are also preferable.

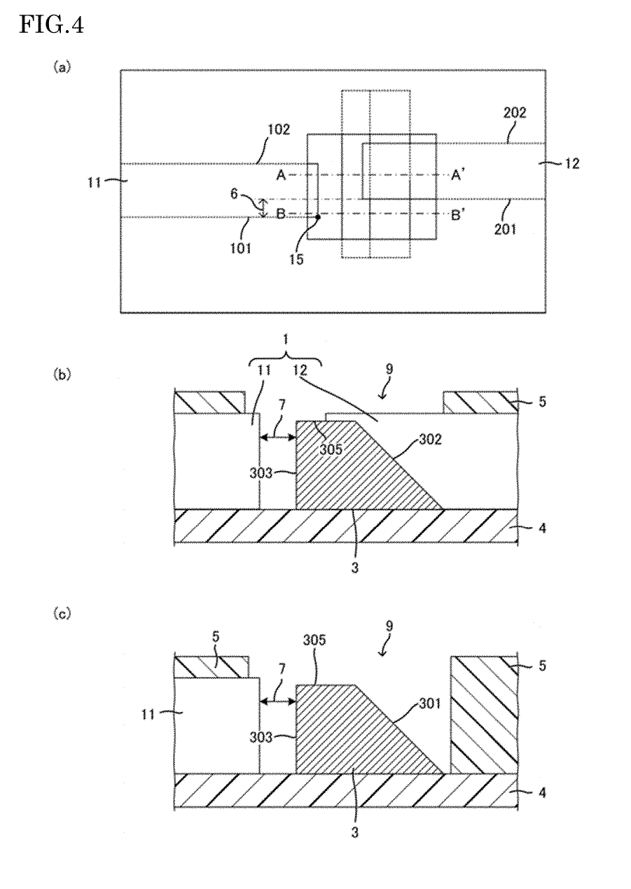

The shapes of the sections other than the optical path converting mirror 301 (for example, the substantially orthogonal surface 303 and the like) are not particularly limited as long as the propagation of light is not hindered. Still, the side surface at a portion where the light passes through is preferably a substantially orthogonal side surface because the favorable connection with the first core pattern portion 11 and the second core pattern portion 12 can be achieved. When the gap 7 as an air layer is provided between the first core pattern portion 11 and the optical path converting mirror member 3 as illustrated in FIG. 4, the substantially orthogonal side surface can achieve a lower coupling loss and thus is particularly preferable.

The shapes illustrated in FIGS. 6(a) and 6(c) are preferably employed for stably ensuring and maintaining the shape of the optical path converting mirror member. The shapes illustrated in FIGS. 6(a) and 6(b) are preferably employed to achieve a small optical loss. All things considered, the shape illustrated in FIG. 6(a) is most preferable.

### (Angle of Optical Path Converting Mirror)

An angle of the optical path converting mirror 301 is not particularly limited as long as the light entering the optical path converting mirror member is reflected by the optical path converting mirror 301 to have the angle of the optical path significantly changed, that is, as long as the optical path is converted to be in the direction substantially orthogonal to the lower clad layer 4. Still, the angle with respect to the surface of the lower clad layer 4 is preferably 15° to 75°, more preferably 30° to 60°, even more preferably 40° to 50°, and is particularly preferably 43° to 47°. Generally, the light that has entered the optical path converting mirror member has the optical path converted to have the angle twice as large as the angle of the optical path converting mirror 301 (for example, 30° when the angle of the optical path converting mirror 301 is 15°).

### (Location of Optical Path Converting Mirror)

The optical path converting mirror 301 may be provided on an upper surface side (side opposite to the lower clad layer 4) and on a lower surface side of the second core pattern portion 12, or may be disposed on sides of both side surfaces. As illustrated in various drawings attached to this specification, the optical path converting mirror 301 is particularly preferably provided on the side of one of the side surfaces, and more preferably provided on the side of one of the side surfaces of the second core pattern portion 12. This configuration has an advantage in that the position of the optical path converting mirror 301 can be easily recognized as viewed from the upper or lower surface of the optical waveguide 100, the thickness of the optical path converting mirror 301 (optical path converting mirror member 3) can be easily controlled, the light on the optical path as a result of the optical path conversion is emitted from a single point and thus can be condensed with a lens, coupling with respect to an external monitor light receiving element (or a light receiving element for signal transmission) can be easily achieved, and the like.

### (Length of Optical Path Converting Mirror Member)

The length of the optical path converting mirror member 3 (the length in the direction orthogonal to the optical path) is not particularly limited as long as the optical path of light conversion is converted, and is preferably set to a length with which the optical path conversion is performed for the maximum possible amount of light propagating toward the optical path converting mirror 301 from the first core pattern portion 11, and may also preferably be set to have an extra length. The length may at least be not shorter than the step-like difference 6. Thus, the lower limit of the length is preferably 1 μm or more, more preferably 10 μm or more, and even more preferably 50 μm or more. The upper limit of the length is preferably 100 mm or less, more preferably 1 mm or less, and even more preferably 250 μm or less.

### (Length of Optical Path Converting Mirror Member)

The length of the upper surface of the optical path converting mirror member in the optical path direction, which is not particularly limited, is preferably 1 μm to 500 μm to achieve a small coupling loss and to favorably maintain the shape of the optical path converting mirror member 3. The length is more preferably 10 μm to 250 μm to control the branching ratio. The length is even more preferably 10 μm to 100 μm to make the spot diameter of the light as a result of the optical path conversion from the optical path converting mirror 301 small, and to achieve favorable coupling with the monitor light receiving element and the light receiving element for optical signal transmission.

### (Height of Optical Path Converting Mirror Member)

The height of the optical path converting mirror member 3 (the distance in the orthogonal direction from the upper surface of the lower clad layer 4) may be about the same as the thickness of the core 1. When the first core pattern portion 11 and/or the second core pattern portion 12 is laminated to be formed after the optical path converting mirror member 3 is formed, the height of the optical path converting mirror member 3 is preferably smaller than the thickness of the thinner one of the first core pattern portion 11 and the second core pattern portion 12 by a difference that is larger than 0 and not larger than 40 μm to ensure the flatness of the upper surfaces of the first core pattern portion 11 and the second core pattern portion 12. The difference is more preferably larger than 0 and not larger than 20 μm and is even more preferably larger than 0 and not larger than 5 μm to achieve a smaller coupling loss with respect to the optical path converting mirror 301. For example, in the embodiment described later, the thickness of the first core pattern portion 11 and the second core pattern portion 12 is 45 μm and the thickness of the optical path converting mirror member 3 is 43 μm (2 μm lower).

The first core pattern portion 11 and the second core pattern portion 12 of the optical waveguide of the present invention that form the core 1 may be physically separated from each other, and thus the gap 7 may be provided between the first core pattern portion 11 and the second core pattern portion 12 and/or the optical path converting mirror member 3 (for example, FIGS. 3, 4, and 5(f) to 5(k)). As illustrated in FIG. 3, the gap 7 may preferably be filled with the upper clad layer 5, or formed in the opening 9, whereby the air serves as the gap 7. The gap 7 is preferably buried with the upper clad layer 5 as illustrated in FIGS. 3, and 5(f) to 5(k) to achieve a low coupling loss between the first core pattern portion 11 and the second core pattern portion 12 and/or the optical path converting mirror 301.

When the gap 7 is provided, the width of the gap 7 (the length in the optical path direction) is not particularly limited but is preferably short to make the spot diameter of the light as a result of the optical path conversion small. Specifically, the width of the gap 7 is preferably 1000 μm or less, more preferably 500 μm or less, and is even more preferably 100 μm. The lower limit of the width, which may be any number larger than 0, is 0.01 μm, for example.

In the optical waveguide of the present invention, at least a part of the optical path converting mirror may be disposed to overlap with the extension of the one side surface 101 of the first core pattern portion 11 and the extension of the one side surface 201 of the second core pattern portion 12. Thus, the optical path of a part of the light can be efficiently converted.

In the optical waveguide of the present invention, the first core pattern portion 11 and the second core pattern portion 12 are optically connected to each other, and the edge line 306 of the optical path converting mirror formed of the inclined surface and the other surface may be disposed closer to the emission plane 13 than the restriction release plane 16. Thus, the restriction release plane 16 is preferably disposed closer to the first core pattern portion 11 than the optical path converting mirror 301.

In the optical waveguide of the present invention, the optical path converting mirror 301 and the second core pattern portion 12 are preferably physically connected to each other. The optical path converting mirror 301 and the second core pattern portion 12 may be connected to each other in a direction substantially orthogonal to the optical path, so that the light can be propagated with a small loss to the optical path converting mirror 301 and the second core pattern portion 12 connected to each other. In this configuration, the side surface 201 of the second core pattern portion 12 is partially on the same plane as the inclined surface of the optical path converting mirror, and thus continues to the side surface 201 of the second core pattern portion on the lower clad layer 4. Thus, the propagation with a smaller loss can be achieved.

The bottom surface of the optical path converting mirror member 3 is preferably on the same plane as the bottom surface of the second core pattern portion 12, so that the amount of the light components that are not introduced to the optical path converting mirror 301 and the second core pattern portion 12 can be reduced to facilitate an attempt to achieve a smaller loss. In the present embodiment, the surface of the lower clad layer 4 serves as the same plane.

Furthermore, the bottom surface of the optical path converting mirror member 3 and the bottom surface of the first core pattern portion 11 are preferably on the same plane. With this configuration, when the optical path converting mirror member 3 and the first core pattern portion 11 are connected to each other as illustrated in FIGS. 1, 2, and 5(a) to 5(e) in particular, a coupling loss between the first core pattern portion 11 and the optical path converting mirror member 3 can be reduced, whereby an attempt to reduce a loss is facilitated. In FIGS. 1, 2, and 5(a) to 5(e), the surface of the lower clad layer 4 serves as the same plane.

In the optical waveguide of the present invention, the cross-sectional area of the first core pattern portion 11 on the restriction release plane 16 may be larger than the cross-sectional area of the second core pattern portion 12 on the emission plane. Thus, the first core pattern portion 11 has the side surface 101, on the side of the optical path converting mirror 301, not on the same plane as the side surface 201 of the second core pattern portion, and the side surface 102, on the side opposite to the optical path converting mirror 301, can be smoothly connected to the side surface 202 of the second core pattern portion 12 easily.

Thus, as illustrated in FIGS. 5(a) and 5(f), the first core pattern portion 11 may have a uniform width larger than the width of the second core pattern portion 12. As illustrated in FIGS. 1, 2, 5(b) to 5(d), and 5(g) to 5(i), an enlarged portion, having an increasing width with a step-like shape or a tapered shape, may be provided on the upstream side of the restriction release plane 16. With the step-like shape or the tapered shape, the number of times the light, propagating in the first core pattern portion 11, is reflected on the side surfaces increases. This configuration is preferable because the branching ratio can be prevented from largely fluctuating even when the spreading angle of the light entering the first core pattern portion 11 fluctuates or when the first core pattern portion 11 is short.

The optical waveguide according to the present embodiment may further include an upper clad layer 5 that is disposed over the lower clad layer 4 in such a manner as to at least partially cover the core 1 and the optical path converting mirror member 3. Thus, a large portion of the core 1 and the optical path converting mirror member 3 can be protected.

When provided, the upper clad layer 5 preferably includes an opening 9 such that the optical path converting mirror member 3 at least partially comes into contact with a matter with a smaller refractive index than the optical path converting mirror member 3. The material with a smaller refractive index than the optical path converting mirror member 3 may be air. More specifically, a part of the optical path converting mirror member 3 may be exposed to the air through the opening 9. The portion of the optical path converting mirror member 3 exposed through the opening 9 functions as the optical path converting mirror 301 of an air reflection type.

Instead of using the optical path converting mirror 301 of the air reflection type as described above, the inclined surface of the optical path converting mirror member 3 may be partially provided with a reflective metal layer so that this portion functions as the optical path converting mirror 301 of a metal reflection type.

When the opening 9 is provided, the first core pattern portion 11, the second core pattern portion 12, the optical path converting mirror member 3, and the lower clad layer 4 may each have a surface partially exposed through the opening. The inclined surface formed in a portion of the optical path converting mirror member 3 not used as the optical path converting mirror 301 may be buried. Any shape that satisfies the condition described above such as rectangular, circular, or polygonal shape may be selected as the shape of the opening 9. With the opening 9 formed to intentionally expose the surfaces, the optical path converting mirror 301 can be surely formed even when displacement between the opening 9 and the optical path converting mirror 301 occurs.

The upper clad layer 5 may be disposed in a direction in parallel with the plane formed by the lower clad layer 4 and a direction in parallel with the optical path of such a manner that the optical path converting mirror 301 and the restriction release plane 16 are clamped. Thus, the optical waveguide can be prevented from deforming at a portion near the restriction release plane 16, and the first core pattern portion 11 and the second core pattern portion and/or the optical path converting mirror 301 can be favorably connected to form the optical path.

### (Optical Device)

One embodiment of the present invention is an optical device including: the optical waveguide described above; a light emitting element that emits light onto the entrance plane 13; the monitor light receiving element that receives at least a part of the light having the optical path converted by the optical path converting mirror 301; and a light receiving element that receives light emitted from the emission plane 14. The optical device of the present invention is described with reference to FIGS. 7 and 8.

The optical device of the present invention includes: the light emitting element (not illustrated) that emits light into the first core pattern portion 11 of the optical waveguide 100; the monitor light receiving element (not illustrated) that receives at least a part of the light having the optical path converted by the optical path converting mirror 301; and the light receiving element (not illustrated) that receives the light emitted from the second core pattern portion 12.

The light emitting element is a member that outputs a signal light for optical signal transmission, and is also a component that converts an electrical signal into an optical signal. The light emitting element emits the signal light into the first core pattern portion 11 of the optical waveguide of the present invention. Specific examples of the light emitting element include a laser diode, an LED, and the like. When the light is input to the first core pattern portion 11 through the light emitting element and another optical component such as an optical waveguide, an optical fiber, a lens, and a mirror, the optical component is also regarded as the light emitting element. The optical signal from the light emitting element may be light of a single mode or multiple modes, or may be light with a wavelength corresponding to any one of ultraviolet light, visible light, and infrared light. Light with a wavelength of 800 nm to 1600 nm that is generally used for light transmission is preferably used.

The light receiving element is a member that receives the signal light for the optical signal transmission, and is also a component that converts the optical signal into an electrical signal. In the optical device of the present embodiment, the light receiving element mainly receives the signal light output from the second core pattern portion 12 in the optical waveguide. Specific examples of the light receiving element includes a photodiode and the like. When another optical component, such as an optical waveguide, an optical fiber, a lens, and a mirror, is disposed between the second core pattern portion 12 and the light receiving element, the optical component is also regarded as the light receiving element.

The monitor light receiving element is a member that receives a part of the signal light for the optical signal transmission that has been branched and monitors the intensity of the signal light. Specific example of the monitor light receiving element, which is not particularly limited as long as the intensity can be monitored, include a photodiode as in the case of the light receiving element. In the optical device of the present embodiment, the monitor light receiving element mainly receives the signal light output from the optical path converting mirror 301 in the optical waveguide. When another optical component, such as an optical waveguide, an optical fiber, a lens, and a mirror, is disposed between the optical path converting mirror 301 and the monitor light receiving element, the optical component is also regarded as the monitor light receiving element.

When the light from the light emitting element and the like enters the first core pattern portion 11 through the entrance plane 13, the light spreads at the restriction release plane 16, and a part of the resultant light travels to the optical path converting member 3 to have the optical path converted by the optical path converting mirror 301. At least a part of the remaining light, with the optical path not converted, propagates in the second core pattern portion 12 to be then emitted from the emission plane 14.

Thus, the monitor light receiving element, for checking whether the light is transmitted, is provided on any one of the optical paths on the side of the optical path converting mirror 301 and on the side of the emission plane 14. The light receiving element, for signal transmission, is provided on the other one of the optical paths. Accordingly, the optical device can be obtained in which a failure that hinders the output from the light emitting element, the optical transmission on the optical path, and the like, can be detected with the monitor light receiving element. An arrangement of the monitor light receiving element and the light receiving element for signal transmission is not particularly limited. Still, the monitor light receiving element is preferably disposed on the side of the optical path converting mirror 301 to achieve a higher degree of design freedom for the electrical wiring for the optical element for the signal transmission.

The branching ratio, which is not particularly limited, is preferably set in such a manner that more light is propagated to the side of the light receiving element for optical signal transmission than the side of the monitor light receiving element. More specifically, the ratio is preferably 1:99 to 40:60, where the total amount of the light received by the monitor light receiving element and the light receiving element for optical signal transmission is 100. To achieve stable amount of light received by the monitor light receiving element, the ratio is more preferably 2:98 to 55:65, and is even more preferably 8:92 to 30:70.

### (Manufacturing Method)

A manufacturing method for the optical waveguide of the present invention is described below in detail. Terms such as a first step, a second step, and the like in the description below are used only for the sake of description and thus do not indicate that the first and the second steps are executed in this order.

An embodiment of the manufacturing method includes: a first step of forming at least one optical path converting mirror member 3, including the inclined surface, on the lower clad layer 4; and a second step of forming the first core pattern portion 11 and forming the second core pattern portion 12 to cover a part of the inclined surface of the optical path converting mirror member 3.

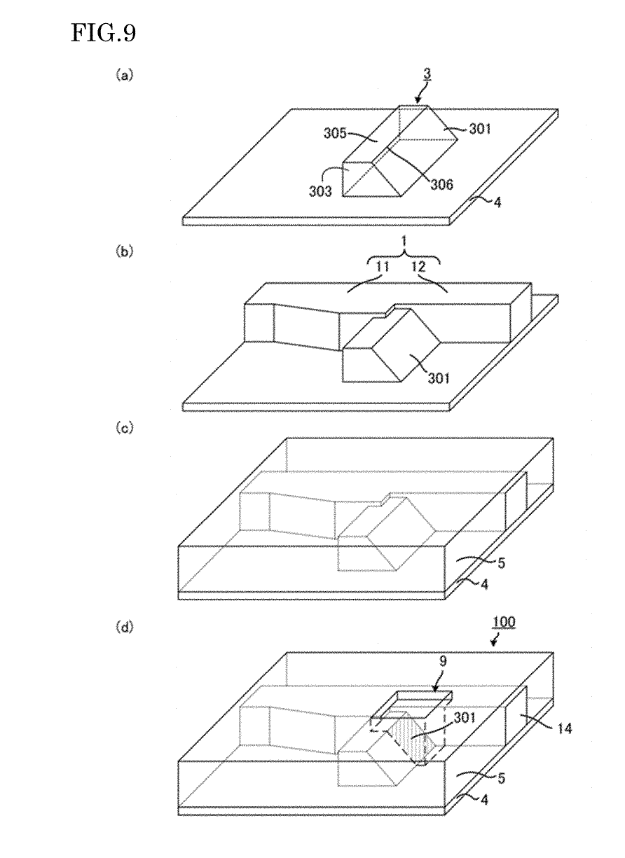

The manufacturing method for the optical waveguide of the present invention is described below in detail with reference to FIG. 9. First of all, as illustrated in FIG. 9(a), the optical path converting mirror member 3, including the inclined surface, is formed on the surface of the lower clad layer 4 (first step). The optical path converting mirror member 3, illustrated in FIG. 9(a), has a half trapezoidal cross-sectional shape, and includes the optical path converting mirror 301, a substantially orthogonal surface 303, an upper surface 305, and an edge line 306 formed by the optical path converting mirror 301 and the upper surface 305.

A forming method for the optical path converting mirror member 3, which is not particularly limited, includes; a method of using a mold curved into a shape of the optical path converting mirror member 3 and the like, and transferring the optical path converting mirror member 3 onto the surface of the lower clad layer 4; a forming method employing a photolithography processing; a method of forming a substantially column shaped pattern by photolithography processing, and then forming the inclined surface with a dicing saw, laser machining, and the like; and the like. With the method of forming a substantially column shaped pattern by photolithography, and then forming the inclined surface with the dicing saw, laser machining, and the like, as one of these methods, the positioning with respect to the first core pattern portion 11 and the second core pattern portion 12 can be easily performed and the angle of the inclined surface can be easily controlled, and thus this method is preferably used.

Then, the first core pattern portion 11 is formed, and the second core pattern portion 12 is formed to cover a part of the inclined surface of the optical path converting mirror member 3, whereby a structure illustrated in FIG. 9(b) is obtained (second step). Thus, the first core pattern portion 11 that is in connection with at least a part of the inclined surface through the optical path converting mirror member 3 in such a manner that a light beam can pass therebetween, and the second core pattern portion 12 that buries at least a part of the remaining portion of the inclined surface and extends toward a side opposite to first core pattern portion 11 from the optical path converting mirror member 3 are formed.

Referring to FIG. 7, the inclined surface 302 as a part of the optical path converting mirror member 3 loses its function as the optical path converting mirror after being buried with the second core pattern portion 12. Thus, the light entering from the first core pattern portion 11 can be introduced into the second core pattern portion 12 through the buried portion of the inclined surface 302. The portion of the inclined surface not buried with the second core pattern portion 12 can at least partially function as the optical path converting mirror 301.

In the second step, preferably the optical path converting mirror 301 is obtained as follows. Specifically, core pattern forming resin is laminated in such a manner that the optical path converting mirror member 3 is buried, and then the core pattern forming resin on the inclined surface is at least partially removed. For example, a specific method used in the second step includes a method of laminating the resin, for forming the first core pattern portion 11 and/or the second core pattern portion 12, on the lower clad layer 4, and forming a pattern by photolithography process. This method is preferable because excellent positioning with respect to the optical path converting mirror member 3 can be achieved.

Alternatively, an etching process using pattern exposure or developer may be performed. This method is preferable because the second core pattern portion 12 can be formed on the inclined surface 302 with the shape of the optical path converting mirror member 3 maintained. The etching process using the developer, which is not particularly limited, includes a spraying method, a dipping method, a paddling method, a spinning method, a brushing method, a scrubbing method, and the like, for example.

As the developer, which is not particularly limited as long as the material forming the core 1 can be etched, various solutions for general use, alkaline solution, acid solution, or a mixture of these is used.

When the optical path converting mirror member 3 is formed by etching processing, and the first core pattern portion 11 and/or the second core pattern portion 12 is also formed by etching processing, post exposure (photo-curing for stronger curing) and heat curing may be performed when the optical path converting mirror member 3 is formed, so that the shape can be maintained in the latter etching processing.

### (Method of Laminating Core Forming Resin)

A method of laminating the core 1 forming resin on the lower clad layer 4, which is not particularly limited, includes: a direct laminating method such as spin coating and the like; and an indirect laminating method of forming a core forming resin film in a form of a dry film, and laminating the core forming resin film serving as the core layer on the lower clad layer 4. The indirect laminating method with which the thickness of the core can be controlled and the flatness of the core can be ensured is more preferable, and a method of laminating the core forming resin film with a roll laminator, a plate laminator, and the like is even more preferable.

When the optical path converting mirror member 3 is buried with the core forming resin, unevenness might be formed at the surface of the core 1 close to the optical path converting mirror member 3. The unevenness thus formed is likely to cause optical loss. Thus, a step of flattening the core forming resin surface is preferably further executed. This flattening method includes a method of pressing the core layer with a rigid plate on the surface on the side opposite to the lower clad layer 4 at the timing when the core forming resin is laminated or after the laminating.

### (Core Forming Resin Laminating Method for Simultaneous Forming)

The first core pattern portion 11 and the second core pattern portion 12, which may be formed with separate steps, are preferably formed with a single step because correlation between their positions is more likely to be ensured. In this context, the first core pattern portion 11 and the second core pattern portion 12 are more preferably formed with the same material. When the photolithography processing is employed, the first core pattern portion 11 and the second core pattern portion 12 may be defined with a single photo tool (for example, a photomask and the like). When the etching processing is employed, the portions may be formed simultaneously.

Through the second step, the inclined surface is partially buried with the second core pattern portion 12. Thus, the light that is emitted from the first core pattern portion 11 and propagated to the buried inclined surface 302 passes through the inclined surface to propagate toward the second core pattern portion 12. Furthermore, the optical path converting mirror 301 can be formed by etching (the inclined surface from which the second core pattern portion 12 forming resin serves as the optical path converting mirror 301). Thus, the second core pattern portion 12 and the optical path converting mirror 301 can be efficiently formed in an accurately positioned manner.

As described above, the first core pattern portion 11 and the second core pattern portion 12 are most preferably formed simultaneously, so that in the obtained optical waveguide, the first core pattern portion 11, the second core pattern portion 12, and the optical path converting mirror 301 can be highly accurately positioned.

The configuration illustrated in FIG. 9(b) already has the function of the optical waveguide, and thus can be used as the optical waveguide. Still, the upper clad layer 5 that at least partially covers the core 1 and the optical path converting mirror member 3 may be provided to protect the core 1 and the optical path converting mirror member 3 from external force, to achieve an easily handled flat structure of the optical waveguide, or for other like purposes. Thus, a third step of forming the upper clad layer 5 to bury at least a part of the core as illustrated in FIG. 9(c), and then forming the opening 9 above the optical path converting mirror as illustrated in FIG. 9(d), may be performed. By forming the opening 9, the exposed portion of the optical path converting mirror member 3 functions as the optical path converting mirror 301. As described above, this optical path converting mirror 301 may be optical path converting mirror 301 of the air reflection type or may be the optical path converting mirror 301 of the metal reflection type with the reflective metal layer provided on the inclined surface 301 after the second core pattern portion 12 is formed.

When the optical path converting mirror 301 of the air reflection type is used, the opening 9 of the upper clad layer 5 may be formed in such a manner that at least the portion to be used as the optical path converting mirror 301 is formed as an air layer (that the opening 9 incorporates the portion serving as the optical path converting mirror 301). Furthermore, the surface of each of the first core pattern portion 11, the second core pattern portion 12, the optical path converting mirror member 3, and the lower clad layer 4 may be partially exposed through the opening.

Any shape that satisfies the condition described above, such as a rectangular shape, a circular shape, a polygonal shape, and the like, may be selected as the shape of the optical path converting mirror 301 (for example, the optical path converting mirror 301 illustrated in FIG. 9(d) has a rectangular shape). With the opening 9 formed for the intentional exposure to the outside, the optical path converting mirror 301 can be surely formed even when the displacement between the opening 9 and the optical path converting mirror 301 occurs.

Furthermore, with the upper clad layer 5 arranged in parallel with the lower clad layer 4 and the optical path of such a manner that the optical path converting mirror 301 and the restriction release plane 16 are clamped, the optical waveguide is prevented from deforming at a portion close to the restriction release plane 16, whereby the first core pattern portion 11 and the second core pattern portion 12 and/or the optical path converting mirror 301 can be favorably connected to form the optical path.

The forming method for the upper clad layer 5, which is not particularly limited, may be a method of laminating upper clad layer forming resin in such a manner that the first core pattern portion 11 and the second core pattern portion 12 are buried, and forming the opening 9 by lithography processing. The forming method employing the laminating method, photolithography processing, etching processing, and the like similar to those employed for the core pattern forming resin is more preferable because accurate positioning of the opening 9 and the optical path converting mirror 301 is more likely to be ensured, and the upper clad layer forming resin on the inclined surface serving as the optical path converting mirror 301 can be efficiently removed.

In the manufacturing method, the core 1 is formed after the optical path converting mirror member 3 is formed. Thus, there is an advantage that the branching with the predetermined branching ratio can be achieved even when a slight displacement between the optical path converting mirror member 3 and the core 1 occurs.

More specifically, for example, when the optical path converting mirror member 3 is displaced in the orthogonal direction (upper and lower direction in the figure) with respect to the optical path of the optical waveguide illustrated in FIGS. 1 to 5, the optical path converting mirror 301 is also displaced in accordance with the amount of the displacement. This is because the inclined surface adjacent to the side surface 201 of the second core pattern portion 12 always serves as the optical path converting mirror 301. In the case illustrated in FIGS. 3, 4, 5(e), and 5(j), any amount of displacement is permitted as long as the inclined surface adjacent to the side surface 201 of the second core pattern portion 12 can be formed. Furthermore, in FIGS. 1, 2, 5(a) to 5(i), and 5(k), the displacement is preferably in an amount with which the optical path converting mirror member 3 does not protrude beyond the second core pattern portion 12. In other words, any amount of displacement that does not involve the protruding is acceptable.

The present manufacturing method further has an advantage that the branching with the predetermined branching ratio can be achieved even when the displacement between the optical path converting mirror member 3 and the optical path of the parallel direction (a left and right direction in the figures) occurs in the optical waveguides illustrated in FIGS. 1 to 5. For example, in the cases illustrated in FIGS. 1, 2, and 5(a) to 5(e), the branching ratio is not largely affected as long as the position (that is not the restriction release plane 16), where change in the surface direction occurs on the side surface 101 and the side surface 202 of the first core pattern portion 11 and the second core pattern portion 12 that are in communication, is disposed on the upper surface 305 of the optical path converting mirror member 3. When the gap 7 is provided between the restriction release plane 16 and the optical path converting mirror member 3 as illustrated in FIGS. 3, 4, and 5(f) to 5(k), the branching ratio is not affected as long as the amount of displacement is within the width of the gap 7. Still, it should be noted that a change in the distance between the restriction release plane 16 and the optical path converting mirror 301 might change the shape of the spot of the light from the optical path converting mirror 301 having the optical path converted. In this regard, the configuration without the gap 7 is more preferable.

Considering that the optical path converting mirror member 3 might be displaced with respect to the optical path of the horizontal direction in the configuration where the optical path converting mirror member 3 is connected to the first core pattern portion 11 having the side surface 101 with a tapered portion 8 as illustrated in FIGS. 1, 2, and 5(d), an end point is disposed closer to the entrance plane 13 than the restriction release plane 16. Thus, an extending direction of the optical path converting mirror member 3 (optical path converting mirror 301) can be kept substantially orthogonal to the side surface 101 of the first core pattern portion 11 even when the displacement occurs. As a result, the width of the optical path at the restriction release plane 16 is likely to be kept constant even when the displacement occurs, whereby the predetermined branching ratio can be ensured.

### (Material)

Next, materials used for the optical waveguide of the present invention and in the manufacturing method the optical waveguide will be described in detail.

### (Materials of Lower Clad Layer and Upper Clad Layer)

The lower clad layer 4 and the upper clad layer 5 preferably have a lower refractive index than the core 1, and more preferably have a lower refractive index than the optical path converting mirror member 3.

The material of the lower clad layer 4 and the upper clad layer 5 is preferably a resin composition that is cured by light or heat, and includes, for example, thermosetting resin composition, photosensitive resin composition, and the like. The photosensitive resin composition may be used when the photolithography processing is executed for forming the opening on the upper clad layer 5.

The lower clad layer 4 and the upper clad layer 5 may be made of the same material or different materials, and may be made of materials with the same or different refractive indices.

### (Material of Optical Path Converting Mirror Member)

The optical path converting mirror member 3 may be designed to have the higher refractive index than the lower clad layer 4. With this configuration, the light propagating in the optical path converting mirror member 3 spreads toward the lower clad layer 4, whereby the light components that cannot reach the optical path converting mirror 301 and the light components that cannot reach the second core pattern portion 12 can be prevented from being generated. As a result, the optical waveguide with a small loss can be obtained.

When the light passes through the buried inclined surface 302 of the optical path converting mirror member 3 to be propagated toward the second core pattern portion 12, the difference between the optical path converting mirror member 3 and the second core pattern portion 12 in the refractive index is preferably small. Specifically, the absolute value of the difference in the refractive index is preferably 0.1 or smaller because a small loss due to the refraction and the reflection on the inclined surface can be achieved, more preferably 0.05 or smaller because a smaller loss can be achieved, and even more preferably 0.01 or smaller, and particularly preferably 0.001 or smaller. It is extremely preferable when there is no difference in the refractive index.

### (Substrate)

The lower surface of the lower clad layer 4 (surface opposite to the surface provided with the core 1) may be provided with a substrate to ensure flatness of the lower clad layer 4, provide the rigidity to the lower clad layer 4, or for other like purposes. For example, the substrate, which is not particularly limited, includes a glass epoxy resin substrate, a ceramic substrate, a glass substrate, a silicon substrate, a plastic substrate, a metal substrate, a substrate with a resin layer, a substrate with a metal layer, a plastic film, a plastic film with a resin layer, a plastic resin with a metal layer, an electrical wiring board, and the like. A flexible and strong substrate may be used to provide flexibleness. When the substrate is disposed on a side where the optical path conversion takes place, a light transmitting substrate or a substrate with an opening through which the light passes through may be used.

### (Lid)

The optical waveguide of the present invention may further include a lid on the upper clad layer 5. The lid covering the opening 9 has an effect of preventing a foreign matter from attaching the optical path converting mirror 301 and the like. The lid may be in a form of a tent so as not to be in contact with the optical path converting mirror 301.

### (Other Modification)

Various modifications and application examples of the optical wave guide, the optical device, and the manufacturing method of the present invention, exemplarily described above, can be made based on the technical idea of the present invention and are described below.

A modification of the optical waveguide of the present invention includes a configuration in which the first core pattern portion 11 and the second core pattern portion 12 are linearly coupled to each other (a straight core pattern portion with no step-like difference on a side surface portion), and one of side surfaces of the optical path converting mirror member 3 orthogonal to the optical path is buried with the straight core pattern portion as illustrated in FIGS. 1, 2, and 5(a) to 5(k). The optical path converting mirror member 3 may have a height large enough to protrude from the surface of the lower clad layer 4 and smaller than the height of the straight core pattern portion. With this configuration, the amount of light to have the optical path converted can be adjusted by adjusting the length of the upper surface 305 of the optical path converting mirror member 3 in the direction of the optical path. More specifically, when the upper surface 305 is set to be longer, the part of the light can have the optical path converted by the optical path converting mirror 301 with a larger amount of light components spreading in a direction parallel to the optical path. The light propagating in the core pattern portion above the optical path converting mirror member 3 is linearly propagated without interference, and thus the loss can be prevented from increasing.

### (Modification of Core Pattern Portion)

FIGS. 1 to 5 describe above each illustrate an example where the number of each of the first core pattern portion 11 and the second core pattern portion 12 is one (one set). Alternatively, the optical waveguide may include two or more sets arranged substantially in parallel with each other. The optical waveguide of the present invention and a normal straight core pattern portion may be disposed. Thus, the sets may be arranged in such a manner that any desired one of the core pattern portions arranged in parallel as described above can be set as the branching destination.

The optical waveguide may have a shape obtained by flipping the shape illustrated in each of FIGS. 1 to 5 in the upper and lower direction and in the left and right direction, or a shape as the mixture of these.

### (Arrangement of Branching Portion)

FIGS. 1 to 5 each illustrate an example where the first core pattern portion 11 and the second core pattern portion are arranged substantially linearly. Alternatively, the first core pattern portion 11 and the second core pattern portion 12 may each have a curved portion, or another optical path converting mirror may be provided on the optical path. When the other optical path converting mirror, converting an optical path of a direction that is the same as that of the optical path as a result of the conversion by the optical path converting mirror 301, is disposed on the optical path of the second core pattern portion 12, the monitor light receiving element and the light receiving element for optical signal transmission can be disposed on the same substrate. When the monitor light receiving element is disposed close to the light receiving element for optical signal transmission, the eligibility of a large portion of a line (optical path) from the light emitting element to the light receiving element for optical signal transmission can be monitored.

Furthermore, another optical path converting mirror may be disposed on the upstream side of the optical path converting mirror member 3 on the optical path in the first core pattern portion 11. Thus, the monitor light receiving element and the light emitting element for optical signal transmission can be disposed on the same substrate. With the monitor light receiving element disposed close to the light emitting element for optical signal transmission, the eligibility of the light emitting element can be monitored.

### (Eligibility Determination by Monitor)

In the monitor light receiving element, the change (reduction in particular) in the amount of received light and average amount of light per unit time are monitored. Thus, the eligibility of the line and the light emitting element can be monitored as described above. More specifically, the line with the amount of light dropped to a predetermined level may be determined to be ineligible so as not to be used.

(Preferable Eligibility Determination with Line Monitor)

Alternatively, two or more sets each including: an optical device including a light emitting element, an optical path (an optical fiber and an optical waveguide), and a light receiving element; and an optical device including a branching portion between the light emitting element and the light receiving element and a monitor light receiving element that monitors the amount of light, may be arranged in parallel. Thus, the eligibility determination can be performed through comparison with another optical device in the different adjacent set in the rate of change in the amount of light instead of using the change in the amount of light. More specifically, the result of the determination may be ineligible when a difference in the rate of change in the amount of light is produced between the optical devices, and reaches a predetermined level. In particular, when eligibility of a large part of a line is monitored in a configuration where the monitor light receiving element is disposed close to the light receiving element for optical signal transmission as described above, and when the optical path (the optical fiber and the optical waveguide) is at least partially flexible (when a flexible optical path is provided between the light emitting element and the monitor light receiving element), the eligibility determination is more preferably made with the difference in the rate of change in the amount of light (or the rate of change in the average amount of light per unit time). This is because a result of the eligibility determination using the change in the amount of light might be wrong due to the change in the branching ratio between the monitor light receiving element and the light receiving element for optical signal transmission. The change in the amount of light occurs due to change in a spreading angle of the light attributable to curving and the like of the flexible optical path of which the light propagates. Still, when the optical devices are arranged substantially in parallel, a result of the eligible determination using the difference in the rate of the change in the amount of light is less likely to be wrong, because the optical devices are similar to each other in how the spreading angle changes. The amount of light as a reference of the rate of the change in the amount of light may be derived from the initial property at the time when the optical device is established.

### EXAMPLE

The present invention is described more in detail below with reference to Examples. The present invention is not limited to Examples described below, and any modification can be made without departing from the gist of the present invention.

### Example 1

### (Preparing Optical Waveguide)

A film was prepared in which the lower clad layer 4 forming photosensitive resin (product name; C73 manufactured by Hitachi Chemical Company, Ltd. with a refractive index after curing: 1.536) was applied and formed on a polyimide substrate (product name; Kapton EN manufactured by DU PNT-TORAY CO., LTD) having a size of 25 μm (thickness)×100 mm×100 mm and a PET film (“Cosmo shine A4100” manufactured by Toyobo Co., Ltd. with a thickness of 50 μm). The photosensitive resin layer of the film was placed entirely on the substrate in a facing manner, vacuumed to be 500 Pa or less, and then was bonded by heat and pressure under a condition with a pressure of 0.7 MPa, a temperature of 70° C., and pressuring time of 30 seconds with a vacuum pressure laminator (product name MVLP-500 manufactured by MEIKI CO., LTD.). Then, the layer was irradiated with ultraviolet light (wavelength of 365 nm) at 1 J/cm² via the PET film with an ultraviolet light exposure device (product name: EV-800 manufactured by Hitachi Via Mechanics, Inc.). Then, the PET film was removed, and the photosensitive resin layer was cured with heat at 170° C. for one hour, whereby the lower clad layer 4 with the thickness of 10 μm was formed on the polyimide substrate.

Then, the optical path converting mirror member 3 forming resin (product name; AD193 manufactured by Hitachi Chemical Company, Ltd. with a refractive index after curing: 1.555) in a form of a dry film applied on a PET film (“Cosmo shine A1517” manufactured by Toyobo Co., Ltd. with a thickness 16 μm) was bonded with heat and pressure with the vacuum pressure laminator under the same condition. Then, the resin was irradiated with ultraviolet light (wavelength of 365 nm) at 3 J/cm² with the exposure device via a negative photomask with an opening for forming a pattern for the optical path converting mirror member 3. Then, the PET film was removed, and developing was performed with potassium carbonate aqueous solution of 1% by mass. Subsequently, through curing with heat under 170° C. for one hour after further optical curing by radiation of ultraviolet light (wavelength of 365 nm) at 4 J/cm² with the exposing device, the pattern for forming the optical path converting mirror member was formed.

The pattern was a rectangular pattern with a size of 125 μm in the direction orthogonal to the optical path×100 μm in the optical path direction, and 12 pieces of this pattern were arranged in the direction orthogonal to the optical path at a pitch of 250 μm. The height from the surface of the lower clad layer 4 (the thickness of the optical path converting mirror member 3) was 43 μm.

The pattern for forming the optical path converting mirror member thus obtained was cut with a dicing saw (DAC552 manufactured by DISCO Corporation) including a dicing blade with an inclined surface inclined by 45°. Thus, the optical path converting mirror member 3 including the inclined surface 301 inclined by 45° as in the shape illustrated in FIG. 6(a) was formed. Each optical path converting mirror member 3 thus obtained had the upper surface 305 with the width 305a of 50 μm in the optical path direction and the inclined surface with the width 301a of 43 μm in the optical path (as viewed in a direction orthogonal to the substrate). The substantially orthogonal surface 303 opposite to the inclined surface was orthogonal to the lower clad layer 4.

Next, the core 1 forming resin (product name; AD193 manufactured by Hitachi Chemical Company, Ltd. with a refractive index after curing: 1.555) in a form of the dry film applied on the PET film (“Cosmo shine A1517” manufactured by Toyobo Co., Ltd. with a thickness 16 μm) was vacuumed to 500 Pa or less, and then was bonded to the side where the optical path converting mirror member 3 was formed with heat under the condition with a pressure of 0.7 MPa, a temperature of 80° C., and pressuring time of 30 seconds with a vacuum pressure laminator (product name: MVLP-500 manufactured by MEIKI CO., LTD. having a silicon rubber surface as one surface and the SUS surface 403 as the other surface (the SUS surface on the side of the PET film)). The SUS is provided to make the upper surface of the core layer flat. Then, the resin layer was irradiated with ultraviolet light (wavelength of 365 nm) at 3 J/cm² with the exposing device via the negative photomask having the opening for forming the core 1. Then, the PET film was removed, and developing was performed with potassium carbonate aqueous solution of 1% by mass. Subsequently, through curing with heat under 170° C. for one hour after further optical curing by radiation of ultraviolet light (wavelength of 365 nm) at 4 J/cm² with the exposing device, the core 1 was formed. The core 1 had the shape illustrated in FIG. 1, and had the configuration in which the first core pattern portion 11 and the second core pattern portion 12 were integrated.

The first core pattern portion 11 of the core 1 included a straight portion (width of 45 μm) with a length of 50 mm, a tapered portion (width increasing from 45 μm to 55 μm) with a length of 1 mm, and a straight portion (width of 55 μm) with a length of 25 μm that were arranged in this order in a light input direction, and was connected to the optical path converting mirror member 3 that has been formed. The second core pattern portion in the core 1 was a straight portion (width of 45 μm) with a length of 25 mm that had one portion burying the inclined surface of the optical path converting mirror member 3 that has been formed. The side surface 101 of the first core pattern portion 11 near the restriction release plane 16 was in parallel with the side surface 201 of the second core pattern portion 12. The step-like difference 6 (distance between the parallel lines) was 10 μm long. The surface of the optical path converting mirror member 3 orthogonal to the optical path was buried with the second core pattern portion 12 (shape illustrated in FIG. 1). Each of the first core pattern portion 11 and the second core pattern portion 12 had a height of 45 μm from the surface of the lower clad layer 4 and a bottom portion on the same plane as the optical path converting mirror member 3. The first core pattern portion 11 and the second core pattern portion 12 on the optical path converting mirror member 3 had the flat surface formed and the thickness of 2 μm on the optical path converting mirror member 3. Although not elaborated in the figures, 12 sets of the first core pattern portion 11, the second core pattern portion 12, and the optical path converting mirror member 3 were formed.

Next, upper clad layer 5 forming photosensitive resin (product name; C73 manufactured by Hitachi Chemical Company, Ltd. with a refractive index after curing: 1.536) in a form of a dry film applied on the PET film (“Cosmo shine A4100” manufactured by Toyobo Co., Ltd. with a thickness: 50 μm) was vacuumed to 500 Pa or lower, and was bonded with heat on the surface on the side where the core 1 was formed under a condition with a pressure of 0.7 MPa, a temperature of 70° C., and pressuring time of 30 seconds with the vacuum pressure laminator (product name: MVLP-500 manufactured by MEIKI CO., LTD). Then, the resin layer was irradiated with ultraviolet light (with a wavelength of 365 nm) at 0.5 J/cm² with the ultraviolet light exposure device (product name: EV-800 manufactured by Hitachi Via Mechanics, Inc.) via the PET film. Then, the PET film was removed, and developing was performed with potassium carbonate aqueous solution of 1% by mass. Subsequently, through curing with heat under 170° C. for one hour after further optical curing by radiation of ultraviolet light (wavelength of 365 nm) at 4 J/cm² with the exposing device, the upper clad layer 5 including the opening 9 was formed.

The upper clad layer 5 had the thickness of 65 μm from the surface of the lower clad layer 4. The lower clad layer 4, the first core pattern portion 11, the second core pattern portion 12, and the optical path converting mirror member 3 were partially exposed through the opening 9. The total width of the optical waveguide thus obtained was 100 μm.

Then, outer shape cutting was performed with the dicing saw (DAC552 manufactured by DISCO Corporation) with a rectangular dicing blade, whereby the optical waveguide incorporating 12 sets of cores and having a width of 20 mm in the direction of the optical path, and a width of 5 mm in the direction orthogonal to the optical path was prepared. The entrance plane of the first core pattern portion 11 was formed on one end surface, and the emission plane of the second core pattern portion 12 was formed on the other end surface.

A GI50 optical fiber and a laser diode were disposed as the light emitting element on the side of the first core pattern portion 11 of the optical waveguide thus obtained. A signal of 850 nm was output from the laser diode to be input to the GI50 optical fiber with the length of 10 m. The output of the optical fiber was connected to the entrance plane of the first core pattern portion 11. The light receiving element for optical signal transmission was connected to the optical path of the second core pattern portion 12 via the GI50 optical fiber with the length of 5 cm. The monitor light receiving element was disposed on the optical path of the optical path converting mirror. Thus, the optical device in which the signal intensity can be monitored was obtained. It was confirmed that the branching ratio between the side of the monitor light receiving element and the side of the light receiving element was 20:80 in average, the optical signal was able to be transmitted with a small optical loss, and the optical signal was favorably monitored.

Furthermore, each of the 12 sets of the optical waveguides described above was regarded as the optical device (an optical fiber tape with 12CH optical fibers arranged in a horizontal direction was used as the optical fiber). A result of monitoring the rate of the change in the amount of light between adjacent optical device indicated that the optical signal was able to be favorably monitored with a small change in the rate of the change in the amount of light despite slight change in the amount of light, monitored by the monitor light receiving element, due to the bending of the optical fiber.

### Example 2

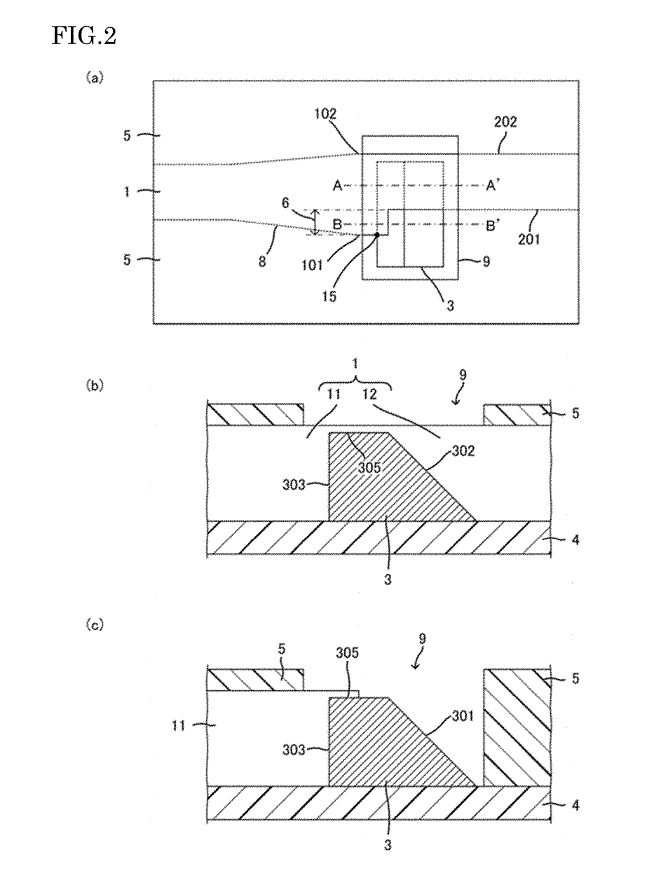

The optical waveguide as illustrated in FIGS. 1 and 2 was prepared in the same manner as in Example 1 except that the maximum width of the tapered portion 8 was set to 50 μm (amount of step-like difference was 5 μm). The branching ratio was 10:90 in average.

In an optical device prepared as in Example 1 with this configuration, the optical signal was able to be propagated, and the optical signal was able to be favorably monitored.

### Example 3

The optical waveguide as illustrated in FIG. 1 was prepared in the same manner as in Example 1 except that the maximum width of the tapered portion 8 was set to 60 μm (amount of step-like difference was 15 μm). The branching ratio was 25:75 in average. In an optical device prepared as in Example 1 with this configuration, the optical signal was able to be propagated, and the optical signal was able to be favorably monitored.

### Example 4

The optical waveguide as illustrated in FIG. 1 was prepared in the same manner as in Example 1 except that the maximum width of the tapered portion 8 was set to 65 μm (amount of step-like difference was 20 μm). The branching ratio was 30:70 in average. In an optical device prepared as in Example 1 with this configuration, the optical signal was able to be propagated, and the optical signal was able to be favorably monitored.

### Example 5

The optical waveguide as illustrated in FIG. 1 were prepared in the same manner as in Example 1 except that the maximum width of the tapered portion 8 was set to 70 μm (amount of step-like difference was 25 μm). The branching ratio was 35:65 in average. In an optical device prepared as in Example 1 with this configuration, the optical signal was able to be propagated despite a slight reduction of amount of light transmitted toward the side of the light receiving element for optical signal transmission, and the optical signal was able to be favorably monitored.

### Example 6

The optical waveguide was prepared in the same manner as in Example 1, except that the first core pattern portion 11 and the second core pattern portion were coaxially formed (no step-like difference) to have the same width (45 μm). The branching ratio was 2:98 in average. In an optical device prepared as in Example 1 with this configuration, the optical signal was able to be propagated with a small loss, and the optical signal was able to be monitored, despite a slight reduction of amount of light transmitted toward the side of the monitor light receiving element.

### Example 7

The optical waveguide was prepared in the same manner as in Example 1, except that no tapered portion 8 was provided and a step form was formed instead as illustrated in FIG. 5(b). The amount of step-like difference 6 was 10 μm. The branching ratio was 20:80 in average. In an optical device prepared as in Example 1 with this configuration, the optical signal was able to be propagated, and the optical signal was able to be favorably monitored.

### Example 8

The optical waveguide was prepared in the same manner as in Example 1, except that 12 optical path converting mirror members 3 were integrally formed by being connected in the direction orthogonal to the optical path, the first core pattern portion 11 was formed to have a linear form (with a width of 45 μm) and was separated from the substantially orthogonal surface 303 of the optical path converting mirror member 3 by the gap 7 (20 μm), the second core pattern portion 12 was formed to have a linear form (with a width of 45 μm), the step-like difference of 10 μm was provided, the optical path converting mirror 301 was exposed through the opening 9, and the gap 7 was buried with the upper clad layer 5 as in the shape illustrated in FIG. 3. The amount of step-like difference 6 was 10 μm. The branching ratio was 20:80 in average. In an optical device prepared as in Example 1 with this configuration, the optical signal was able to be propagated despite a larger loss than that in Example 1, and the optical signal was able to be favorably monitored.

### Example 9

The optical waveguide was prepared as in Example 8 except that the gap 7 was provided in the opening 9 as in the shape illustrated in FIG. 4. In an optical device prepared as in Example 7 with this configuration, the optical signal was able to be propagated despite a larger loss than that in Example 8, and the optical signal was able to be favorably monitored

### Example 10

The optical waveguide was prepared as in Example 8 except that the second core pattern portion 12 was connected to the first core pattern portion 11 with the length of the second core pattern portion 12 extended toward the side of the first core pattern portion 11 as in the shape illustrated in FIG. 5(j). The branching ratio was 20:80 in average. In an optical device prepared as in Example 1 with this configuration, the optical signal was able to be propagated with a small loss, and the optical signal was able to be favorably monitored.

### Example 11

In Example 1, another optical path converting mirror was disposed on the first core pattern portion 11, and the light was emitted from the light emitting element to the other optical path converting mirror without passing through the optical fiber to be propagated in a direction toward the restriction release plane 16. The light emitting element and the monitor light receiving element were able to be disposed on the same plane (element mounting electric wiring board). In an optical device prepared with this configuration, the optical signal was able to be propagated with a small loss, and the optical signal was able to be favorably monitored.

### Example 12

In Example 1, another optical path converting mirror was disposed on the second core pattern portion 12, and the optical signal output from the other optical path converting mirror was received by the light receiving element for optical signal transmission without passing through the optical fiber. The light emitting element and the monitor light receiving element were able to be disposed on the same plane (element mounting electric wiring board). In the optical device prepared with this configuration, the optical signal was able to be propagated with a small loss, and the optical signal was able to be favorably monitored.

### REFERENCE SIGNS LIST

1 Core
11 First core pattern portion
12 Second core pattern portion
13 Entrance plane
14 Emission plane
15 Particular restriction release point
16 Restriction release plane
101 First core pattern portion side surface (side of optical path converting mirror)
102 First core pattern portion side surface (side opposite to optical path converting mirror)
201 Second core pattern portion side surface (side of optical path converting mirror)
202 Second core pattern portion side surface (side opposite to optical path converting mirror)
3 Optical path converting mirror member
301 Optical path converting mirror
302 Buried inclined surface
303 Substantially orthogonal surface of optical path converting mirror member
304 Substantially orthogonal surface of optical path converting mirror member
305 Upper surface of optical path converting mirror member
306 Edge line
301a Width of optical path converting mirror
305a Width of rear converting mirror upper surface
4 Lower clad layer
5 Upper clad layer
6 Step-like difference
7 Gap
8 Tapered portion
9 Opening
100 Optical waveguide

1. An optical waveguide at least comprising:
a lower clad layer;
a core that is disposed on the lower clad layer and includes an entrance plane and an emission plane; and
an optical path converting mirror including an inclined surface that is neither in parallel with nor orthogonal to a plane formed by the lower clad layer, wherein
the core includes a restriction release plane where light that has entered through the entrance plane is first released from restriction of a side surface of the core,
when one of two portions obtained by dividing the core in two at the restriction release plane that is on the side of the entrance plane is defined as a first core pattern portion and remaining one of the two portions on the side of the emission plane is defined as a second core pattern portion, the optical path converting mirror is disposed on an optical path of the first core pattern portion or an extension of the optical path,
at least a part of the light that has entered through the entrance plane is reflected by the optical path converting mirror to have an optical path converted, and
at least a part of light with an optical path not converted to be in a substantially orthogonal direction is emitted from the emission plane.

2. The optical waveguide according to claim 1, wherein one side surface A of the first core pattern portion closest to the restriction release plane and one side surface B of the second core pattern portion that is on the same side as the side surface and is more on the side of the emission plane than an intersecting point where an edge line formed by the inclined surface and another surface of the optical path converting mirror and the side surface intersect as viewed in the direction of the normal line of the lower clad layer are not on the same plane and are arranged in such a manner that an intersection line between the side surface A and the restriction release plane is disposed more on the side of the optical path converting mirror than the side surface B.

3. The optical waveguide according to claim 1, further comprising an optical path converting mirror member that includes the optical path converting mirror and is a column having a triangular or polygonal cross section, wherein
the optical path converting mirror member having the polygonal cross section includes an upper surface in parallel with the plane formed by the lower clad layer, a lower surface substantially in parallel with the plane formed by the lower clad layer, and a surface that is closest to the entrance plane and is substantially orthogonal to the plane formed by the lower clad layer.

4. The optical waveguide according to claim 1, wherein at least a part of the optical path converting mirror is disposed to overlap with an extension of one side surface of the first core pattern portion and an extension of one side surface of the second core pattern portion.

5. The optical waveguide according to claim 1, wherein
the first core pattern and the second core pattern are optically connected to each other, and
the optical path converting mirror is disposed in such a manner that the edge line formed by the inclined surface and the other surface is disposed closer to the emission plane than the restriction release plane.

6. The optical waveguide according to claim 1, wherein the optical path converting mirror and the second core pattern portion are physically connected to each other.

7. The optical waveguide according to claim 1, wherein a cross-sectional area of the first core pattern portion on the restriction release plane is larger than a cross-sectional area of the second core pattern emission plane.

8. The optical waveguide according to claim 1, further comprising an upper clad layer disposed over the lower clad layer to at least partially cover the core and the optical path converting mirror member.

9. The optical waveguide according to claim 8, wherein an opening is formed in the upper clad, so that at least a part of the optical path converting mirror member comes into contact with a material with a smaller refractive index than the optical path converting mirror member.

10. An optical device comprising:
the optical waveguide according to claim 1;
a light emitting element that emits light onto the entrance plane;
a monitor light receiving element that receives at least a part of the light having an optical path converted by the optical path converting mirror; and
a light receiving element that receives the light emitted from the emission plane.

11. The manufacturing method of the optical waveguide according to claim 1, the manufacturing method comprising:
a first step of forming at least one optical path converting mirror member, including an inclined surface, on a lower clad layer; and
a second step of forming a first core pattern portion and a second core pattern portion that covers a part of the inclined surface of the optical path converting mirror member.

12. The manufacturing method of the optical waveguide according to claim 11, wherein in the second step, the optical path converting mirror is obtained by laminating core pattern forming resin to bury the optical path converting mirror member, and removing the core pattern forming resin on at least a part of the inclined surface.

13. The manufacturing method of the optical waveguide according to claim 11, further comprising a third step of forming an upper clad layer to bury at least a part of the core, and then forming an opening on the optical path converting mirror.
